(19) United States
(12) Patent Application Publication
(10) Pub. No.: US 2021/0375078 A1
(43) Pub. Date: Dec. 2, 2021

(54) AUTOMATED VEHICLE BODY DAMAGE DETECTION

(71) Applicant: GM Cruise Holdings LLC, San Francisco, CA (US)

(72) Inventors: Erik Nielsen, Glendale, AZ (US); Michael Schmidt, San Francisco, CA (US)

(21) Appl. No.: 16/885,993

(22) Filed: May 28, 2020

(51) Int. Cl. G07C 5/08; G06Q 10/00; B60R 21/0136

(52) U.S. Cl. CPC G07C 5/0808; G07C 5/0841; B60R 2021/0027; B60R 21/0136; G06Q 10/20

(57) ABSTRACT

The subject disclosure relates to detecting cosmetic damage on a vehicle. The disclosed technology can have one or more processors, a projector system in communication with the one or more processors, the projector system configured to project electromagnetic radiation onto at least one surface of a vehicle and receive, via one or more sensors, sensor data containing at least a portion of the electromagnetic radiation reflected off of the at least one surface of the vehicle, memory storing computer-readable instructions, the instructions effective to cause the one or more processors to receive the sensor data from the projector system, analyze the sensor data based on the reflected electromagnetic radiation and an expected pattern of reflected electromagnetic radiation, and determine if the vehicle has cosmetic damage on the at least one surface of the vehicle based on the analysis of the sensor data. Methods and machine-readable media are also provided.

### BACKGROUND

### 1. Technical Field

The subject technology provides solutions for detecting and identifying damage to a vehicle and in particular for using projector and sensor systems to compare reflected electromagnetic waves off of a body of the vehicle against expected electromagnetic waves.

### 2. Introduction

Over the course of a lifetime of a vehicle, the vehicle will encounter various incidents that result in damage, such as dings, scratches, etc., to a body of the vehicle. As vehicles become more autonomous, there may not always be a human observer to determine whether damage has occurred to the body of the vehicle. Thus, there is a need for automatically detecting damage to the vehicle.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example system that can be used to detect and identify damage to a vehicle, according to some aspects of the disclosed technology.

FIG. 2 illustrates steps of an example process for detecting and identifying damage to a vehicle, according to some aspects of the disclosed technology.

FIG. 3 illustrates additional steps of an example process that may be used in the example process of FIG. 2, according to some aspects of the disclosed technology.

FIG. 4 illustrates an example environment that includes an autonomous vehicle in communication with a remote computing system, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Over the course of a lifetime of a vehicle, the vehicle will encounter various incidents that result in damage, such as dings, scratches, etc., to a body of the vehicle. For example, a dislodged rock may hit the vehicle and cause a ding or a pedestrian may have scratched a door of the vehicle with a personal item. In some extreme cases, a malicious actor may have vandalized the vehicle. As vehicles become more autonomous, there may not always be a human observer to determine whether damage has occurred to the body of the vehicle. Thus, there is a need for automatically detecting damage to the vehicle.

Autonomous vehicles have many sensors to utilize, which may assist in detecting when an incident may have potentially caused damaged to the autonomous vehicle. By communicating with a computing system, the autonomous vehicle may automatically navigate to an inspection facility. Regular inspections by human inspectors may be time consuming, redundant, and/or expensive. Thus, there is also a need for automating inspections to reduce a frequency of human conducted inspections.

Accordingly, the present technology discloses methods and systems for automating inspections for detecting vehicle body damage and reducing human inspections. Aspects of the disclosed technology include utilizing a projector system to project electromagnetic radiation, such as visible light patterns, onto the body of the vehicle. Furthermore, a sensor system, such as a camera, receives and stores reflected electromagnetic radiation (e.g. an image of how the light pattern appears on the body of the vehicle) as sensor data. A computing system receives the sensor data and analyzes the sensor data to determine if the vehicle has damage.

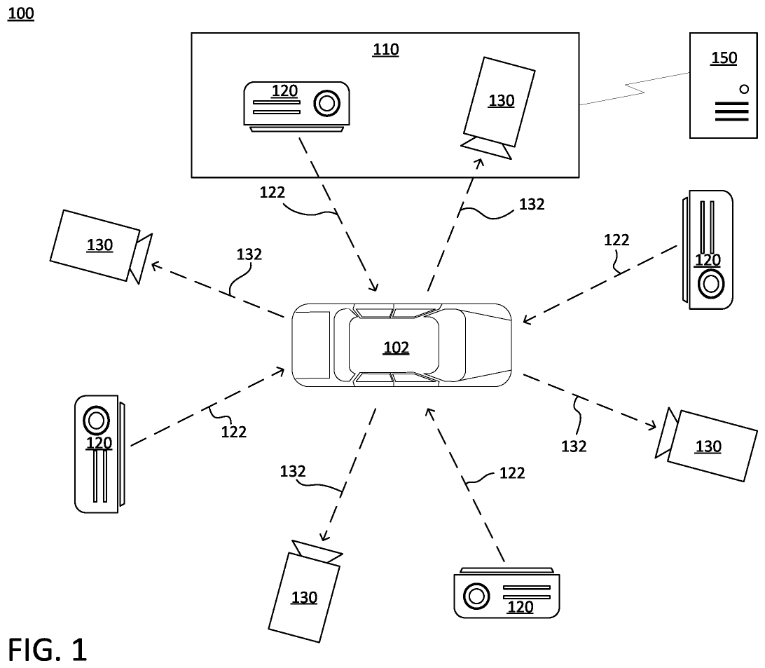

FIG. 1 illustrates an example environment 100, such as an inspection facility, having a vehicle 102, such as an autonomous vehicle. Inspection facility 100 may further have a projector and sensor system 110 in communication with a computing system 150, such as a remote computing system.

Vehicle 102 may be configured to navigate to inspection facility 100 for inspection. More specifically, as vehicle 102 regularly navigates streets over the lifetime of the vehicle 102, the vehicle 102 may encounter various incidents that result in damage, such as dings, scratches, etc. to a body of the vehicle 102. Thus, vehicle 102 may be configured to navigate to inspection facility 100 at set intervals, follow instructions to follow an inspection schedule, or navigate to inspection facility 100 upon detecting an incident that may result in damage.

Projector system and sensor system 110 may have a projector system 120 and a sensor system 130. However, it is to be understood that the projector system 120 and the sensor system 130 may also be separate entities.

Projector system 120 is configured to emit and/or project projected electromagnetic radiation 122, such as visible light, infrared light, ultraviolet rays, laser light, etc. The projected electromagnetic radiation 122 is projected onto at least one surface of the body of the vehicle 102. In some embodiments, the projected electromagnetic radiation 122 may be visible light. In some embodiments, the projected electromagnetic radiation 122 may be in a predetermined or specific pattern, such as multiple parallel lines, a grid, an image, etc. In some embodiments, the predetermined or specific pattern may be selected, such that the predetermined or specific pattern becomes distorted when the selected pattern is projected onto an area with cosmetic damage. For example, a portion of a line or a grid may bend when projected onto an area with a ding. In some embodiments, laser light may be used to determine distances between projector system 120 and portions of at least one surface of the body of the vehicle 102, such that slight changes in distances may indicate damage to the body of the vehicle 102. For example, a scratch or ding may be farther than a remainder of the body of the vehicle 102. In other words, because the scratch or ding may be embedded into a paint of the vehicle 102, the scratch or ding would be distanced farther from the projector system 120.

Sensor system 130 is configured to receive reflected electromagnetic radiation 132, such as visible light, infrared light, ultraviolet rays, laser light, etc. via one or more sensors. The reflected electromagnetic radiation 132 may be projected electromagnetic radiation 122 that is reflected by at least one surface of the body of the vehicle 102. In some embodiments that utilize a predetermined or specific pattern, the reflected electromagnetic radiation 132 may be a portion of the predetermined or specific pattern. More specifically, the reflected electromagnetic radiation 132 may be a distorted reflection of the selected when the vehicle has cosmetic damage. For example, a dent may cause a line or portions of a grid to appear bent or otherwise deformed. Sensor system 130 also stores the received reflected electromagnetic radiation 132 as sensor data.

Computing system 150 is in communication with projector system 110, projector system 120, and/or sensor system 130. Furthermore, computing system 150 is configured to receive and analyze the sensor data to determine if the vehicle has cosmetic damage. In some embodiments, computing system 150 receives, via a communication service the sensor data. The computing system 150 may then analyze the sensor data via an analysis service. In some embodiments, the analysis service may utilize an algorithm and/or a machine learning model, as will be discussed further below. Computing system 150 may then determine if the vehicle has cosmetic damage based on the analysis of the sensor data. In some embodiments, computing system 150 may also generate a damage report of the vehicle. Similarly, in some embodiments, computing system 150 may also create an algorithm configured to receive new sensor data about a vehicle and determine whether the vehicle has cosmetic damage. In some embodiments, computing system 150 is a remote computing system, such that the computing system 150 is in communication with projector system 110 via wireless communications including, but not limited to, cellular technologies, Bluetooth, etc.

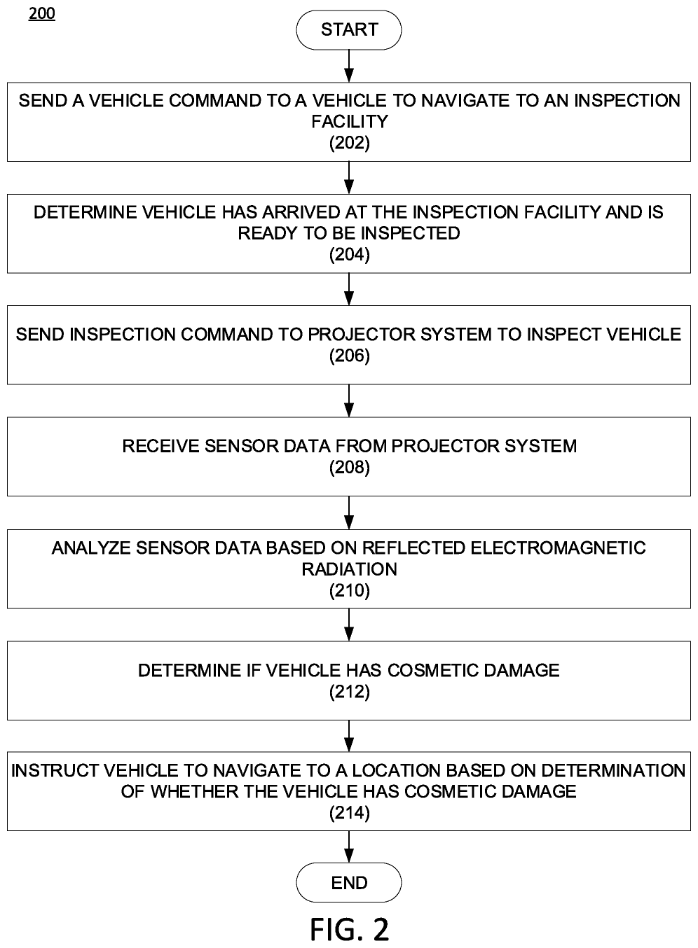

FIG. 2 illustrates steps of an example process 200 for detecting and identifying damage to a vehicle. Process 200 begins with step 202, in which computing system 150 sends a vehicle command to a vehicle 102 to navigate to an inspection facility or site. In some embodiments, computing system 150 may determine a schedule, such that various vehicles may be scheduled to visit the inspection facility. For example, computing system 150 may schedule a first vehicle 102 to arrive at the inspection facility and a second vehicle 102 to arrive at the inspection facility around a time when the first vehicle 102 is ready to leave the inspection facility. Additionally, computing system 150 may adjust the schedule based on various other factors. For example, a first vehicle may have identified that the first vehicle has encountered an impact incident that may result in damage, while a second vehicle may simply be navigating to the inspection facility for routine inspection. Thus, computing system 150 may prioritize the first vehicle. Accordingly, computing system 150 may send a vehicle command to a vehicle 102 after the vehicle 102 has identified an impact event. The vehicle command may also be effective to cause the vehicle 102 to navigate to a specific area within the inspection facility. For example, the inspection facility may have a specific area dedicated to inspecting the vehicle 102. Additionally, the specific area may be determined or selected based on a location, orientation, and/or direction of projector and sensor system 110, projector system 120, and/or sensor system 130.

In step 204, computing system 150 determines that the vehicle 102 has arrived at the inspection facility and is ready to be inspected. Computing system 150 may utilize a variety of different methods and systems to determine that the vehicle 102 has arrived at the inspection facility. For example, computing system 150 may track a location of the vehicle 102 via a global positioning system (GPS). Additionally or alternatively, computing system 150 may communicate with vehicle 102, such that the vehicle 102 may indicate the position of the vehicle 102. Similarly, computing system 150, projector and sensor system 110, projector system 120, and/or sensor system 130 may communicate with vehicle 102 using localized communications including, but not limited to, wireless access networks (WLAN), Near-Field Communications (NFC), Bluetooth, etc. Thus, when the vehicle 102 is connected to the WLAN or other localized network, computing system 150 may determine that the vehicle 102 has arrived at the inspection facility. Additionally, computing system 150 may determine that the vehicle 102 is ready to be inspected when the vehicle 102 has arrived at a specific area dedicated to inspecting the vehicle 102.

In step 206, computing system 150 sends an inspection command to a projector and sensor system 110 or a projector system 120 to inspect the vehicle 102. The inspection command may be effective to cause the systems 110, 120 to project a pattern onto at least one surface of the vehicle 102. In embodiments where the computing system 150 is a remote computing system, computing system 150 may send the inspection command through a communication service.

In step 208, computing system 150 receives sensor data from the projector and sensor system 110 or a sensor system 130. As discussed above, the sensor data includes projected electromagnetic radiation that is reflected by at least one surface of the vehicle 102. In embodiments where the computing system 150 is a remote computing system, computing system 150 receives the sensor data via a communication service.

In step 210, computing system 150 analyzes sensor data based on reflected electromagnetic radiation. As discussed above, the reflected electromagnetic radiation may assist in identifying cosmetic damage. More specifically, computing system 150 analyze the reflected electromagnetic radiation against an expected electromagnetic radiation. For example, computing system 150 may analyze a reflected pattern against an expected pattern, which may be based on a vehicle with no cosmetic damages. Thus, deviations from and/or distortions of the expected pattern may indicate that the vehicle 102 has damage. Similarly, if the reflected electromagnetic radiation pattern matches the expected pattern of reflected electromagnetic radiation, there is little to no damage. Similarly, computing system 150 may analyze a reflected pattern against an expected pattern, which is based on a vehicle with known damage.

In step 212, computing system 150 determines if the vehicle 102 has cosmetic damage. As discussed above, computing system 150 may determine, based on the analysis of the sensor data, if the vehicle 102 has damage. For example, if the reflected electromagnetic radiation pattern matches the expected pattern of reflected electromagnetic radiation, computing system 150 may determine that there is little to no damage. In some embodiments, computing system 150 may determine that the vehicle 102 has damage and that the damage is within an acceptable range, such that the damage is not critical and/or requiring repairs.

In step 214, computing system 150 instructs the vehicle 102 to navigate to a location based on the determination of whether the vehicle 102 has cosmetic damage. If the vehicle 102 has cosmetic damage, computing system 150 may instruct the vehicle to navigate to a repair facility. In some embodiments, the repair facility may be a different area of the inspection facility. If the vehicle 102 does not have cosmetic damage or if the damage is within an acceptable range, computing system 150 may instruct the vehicle to navigate to a cleaning facility, a charging station, and/or to return to ridesharing activities.

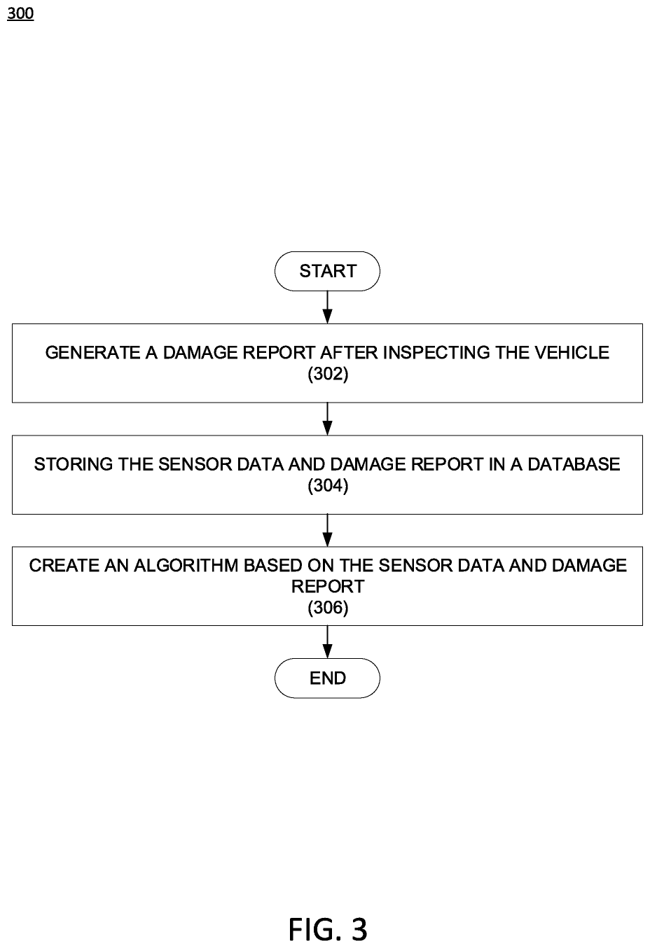

FIG. 3 illustrates steps of an example process 300 for detecting and identifying damage to a vehicle. Process 300 may be additional steps for process 200 or a stand-alone process. Process 300 begins with step 302, in which computing system 150 generates a damage report after inspecting the vehicle 102. The damage report may indicate a variety of different factors including, but not limited to, whether the vehicle 102 had damage, whether the damage is within an acceptable range, miles driven since the last inspection, etc. In some embodiments, the damage report may indicate that the vehicle has received damage but is near an acceptable range. Thus, computing system 150 may instruct the vehicle 102 to have a secondary inspection conducted by a human inspector. The human inspector may then inspect the vehicle 102 and update the damage report to indicate whether the damage is within the acceptable range.

In step 304, computing system 150 stores the sensor data and the damage report in a database.

In step 306, computing system 150 creates an algorithm based on the sensor data and the damage report in the database. The algorithm may then receive inputs of new sensor data of a second vehicle to analyze against sensor data and damage reports in the database. The algorithm may then determine, based on the analysis of the new sensor data, sensor data, and damage reports, whether the second vehicle has damage. Similarly, the algorithm and/or a second algorithm may analyze new sensor data of the same vehicle to analyze against sensor and damage reports of the same vehicle in the database to determine whether the same vehicle has received new damage since the last inspection. In other words, the previous sensor data becomes the expected pattern to compare the reflected pattern against. The algorithm and/or the second algorithm may then be used in subsequent analyses.

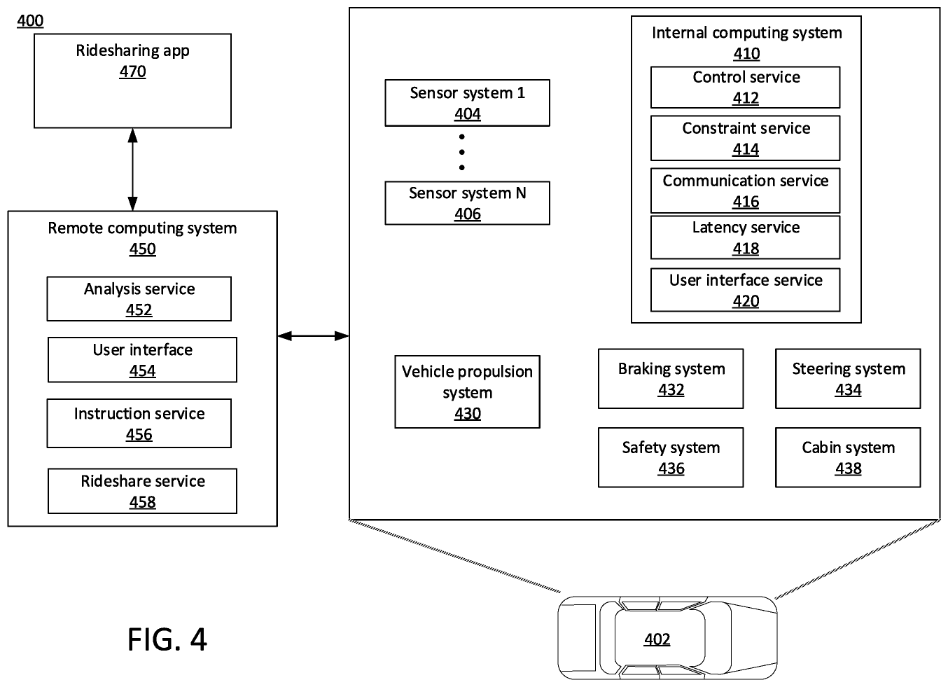

FIG. 4 illustrates environment 400 that includes an autonomous vehicle 402 in communication with a remote computing system 450. As discussed above, computing system 150 may be the remote computing system 450.

The autonomous vehicle 402 can navigate about roadways without a human driver based upon sensor signals output by sensor systems 404-406 of the autonomous vehicle 402. The autonomous vehicle 402 includes a plurality of sensor systems 404-406 (a first sensor system 404 through an Nth sensor system 406). The sensor systems 404-406 are of different types and are arranged about the autonomous vehicle 402. For example, the first sensor system 404 may be a camera sensor system, and the Nth sensor system 406 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 402 further includes several mechanical systems that are used to effectuate appropriate motion of the autonomous vehicle 402. For instance, the mechanical systems can include but are not limited to, a vehicle propulsion system 430, a braking system 432, and a steering system 434. The vehicle propulsion system 430 may include an electric motor, an internal combustion engine, or both. The braking system 432 can include an engine brake, brake pads, actuators, and/or any other suitable componentry that is configured to assist in decelerating the autonomous vehicle 402. The steering system 434 includes suitable componentry that is configured to control the direction of movement of the autonomous vehicle 402 during navigation.

The autonomous vehicle 402 further includes a safety system 436 that can include various lights and signal indicators, parking brake, airbags, etc. The autonomous vehicle 402 further includes a cabin system 438 that can include cabin temperature control systems, in-cabin entertainment systems, etc.

The autonomous vehicle 402 additionally comprises an internal computing system 410 that is in communication with the sensor systems 404-406 and the systems 430, 432, 434, 436, and 438. The internal computing system includes at least one processor and at least one memory having computer-executable instructions that are executed by the processor. The computer-executable instructions can make up one or more services responsible for controlling the autonomous vehicle 402, communicating with remote computing system 450, receiving inputs from passengers or human co-pilots, logging metrics regarding data collected by sensor systems 404-406 and human co-pilots, etc.

The internal computing system 410 can include a control service 412 that is configured to control the operation of the vehicle propulsion system 430, the braking system 432, the steering system 434, the safety system 436, and the cabin system 438. The control service 412 receives sensor signals from the sensor systems 404-406 as well communicates with other services of the internal computing system 410 to effectuate operation of the autonomous vehicle 402. In some embodiments, control service 412 may carry out operations in concert one or more other systems of autonomous vehicle 402.

The internal computing system 410 can also include a constraint service 414 to facilitate safe propulsion of the autonomous vehicle 402. The constraint service 414 includes instructions for activating a constraint based on a rule-based restriction upon operation of the autonomous vehicle 402. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 412.

The internal computing system 410 can also include a communication service 416. The communication service can include both software and hardware elements for transmitting and receiving signals from/to the remote computing system 450. The communication service 416 is configured to transmit information wirelessly over a network, for example, through an antenna array that provides personal cellular (long-term evolution (LTE), 3G, 5G, etc.) communication.

In some embodiments, one or more services of the internal computing system 410 are configured to send and receive communications to remote computing system 450 for such reasons as reporting data for training and evaluating machine learning algorithms, requesting assistance from remoting computing system or a human operator via remote computing system 450, software service updates, ridesharing pickup and drop off instructions etc.

The internal computing system 410 can also include a latency service 418. The latency service 418 can utilize timestamps on communications to and from the remote computing system 450 to determine if a communication has been received from the remote computing system 450 in time to be useful. For example, when a service of the internal computing system 410 requests feedback from remote computing system 450 on a time-sensitive process, the latency service 418 can determine if a response was timely received from remote computing system 450 as information can quickly become too stale to be actionable. When the latency service 418 determines that a response has not been received within a threshold, the latency service 418 can enable other systems of autonomous vehicle 402 or a passenger to make necessary decisions or to provide the needed feedback.

The internal computing system 410 can also include a user interface service 420 that can communicate with cabin system 438 in order to provide information or receive information to a human co-pilot or human passenger. In some embodiments, a human co-pilot or human passenger may be required to evaluate and override a constraint from constraint service 414, or the human co-pilot or human passenger may wish to provide an instruction to the autonomous vehicle 402 regarding destinations, requested routes, or other requested operations.

As described above, the remote computing system 450 is configured to send/receive a signal from the autonomous vehicle 402 regarding reporting data for training and evaluating machine learning algorithms, requesting assistance from remote computing system 450 or a human operator via the remote computing system 450, software service updates, rideshare pickup and drop off instructions, etc.

The remote computing system 450 includes an analysis service 452 that is configured to receive data from autonomous vehicle 402 and analyze the data to train or evaluate machine learning algorithms for operating the autonomous vehicle 402. The analysis service 452 can also perform analysis pertaining to data associated with one or more errors or constraints reported by autonomous vehicle 402.

The remote computing system 450 can also include a user interface service 454 configured to present metrics, video, pictures, sounds reported from the autonomous vehicle 402 to an operator of remote computing system 450. User interface service 454 can further receive input instructions from an operator that can be sent to the autonomous vehicle 402.

The remote computing system 450 can also include an instruction service 456 for sending instructions regarding the operation of the autonomous vehicle 402. For example, in response to an output of the analysis service 452 or user interface service 454, instructions service 456 can prepare instructions to one or more services of the autonomous vehicle 402 or a co-pilot or passenger of the autonomous vehicle 402.

The remote computing system 450 can also include a rideshare service 458 configured to interact with ridesharing application 470 operating on (potential) passenger computing devices. The rideshare service 458 can receive requests to be picked up or dropped off from passenger ridesharing app 470 and can dispatch autonomous vehicle 402 for the trip. The rideshare service 458 can also act as an intermediary between the ridesharing app 470 and the autonomous vehicle wherein a passenger might provide instructions to the autonomous vehicle 402 to go around an obstacle, change routes, honk the horn, etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

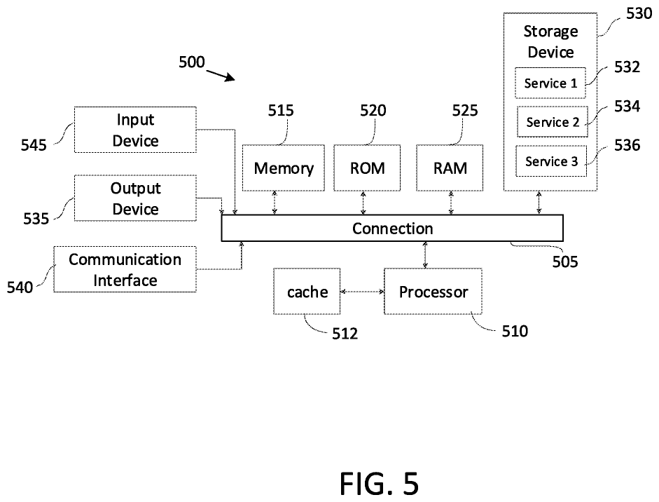

FIG. 5 shows an example of computing system 500, which can be for example any computing device making up computing system 150, internal computing system 410, remote computing system 450, (potential) passenger device executing rideshare app 470, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed:

1. A system comprising:
one or more processors;
a projector system in communication with the one or more processors, the projector system configured to project electromagnetic radiation onto at least one surface of a vehicle and receive, via one or more sensors, sensor data containing at least a portion of the electromagnetic radiation reflected off of the at least one surface of the vehicle; and
memory storing computer-readable instructions, the instructions effective to cause the one or more processors to:
receive the sensor data from the projector system;
analyze the sensor data based on the reflected electromagnetic radiation and an expected pattern of reflected electromagnetic radiation; and
determine if the vehicle has cosmetic damage on the at least one surface of the vehicle based on the analysis of the sensor data.

2. The system of claim 1, wherein the electromagnetic radiation projected onto the at least one surface of the vehicle is visible light in a selected pattern that becomes distorted when the selected pattern is projected onto an area with cosmetic damage.

3. The system of claim 1, wherein if the reflected electromagnetic radiation matches the expected pattern of reflected electromagnetic radiation, determine that the vehicle does not have cosmetic damage on the at least one surface.

4. The system of claim 1, wherein the instructions are further effective to cause the one or more processors to:
instruct the vehicle to navigate to a repair facility if the vehicle has cosmetic damage on the at least one surface.

5. The system of claim 1, wherein the instructions are further effective to cause the one or more processors to:
send a command to the vehicle after the vehicle has identified an impact event, the command effective to cause the vehicle to navigate to an inspection facility having the projector system.

6. The system of claim 1, wherein the instructions are further effective to cause the one or more processors to:
generate a damage report if the vehicle is determined to have cosmetic damage on at least a portion of the vehicle;
store the sensor data and the damage report into a database; and
create an algorithm based on the sensor data and the damage report,
wherein the algorithm is configured to receive new sensor data containing at least a second portion of electromagnetic radiation reflected off of at least one surface of a second vehicle and output whether the second vehicle has cosmetic damage.

7. The system of claim 1, wherein the instructions are further effective to cause the one or more processors to:
instruct the vehicle to return to ridesharing activities or to navigate to a cleaning facility or a charging station if the vehicle does not have cosmetic damage on the at least one surface or that the cosmetic damage is within an acceptable range.

8. A method comprising:
receiving sensor data from a projector system in communication with one or more processors, the projector system configured to project electromagnetic radiation onto at least one surface of a vehicle and receive, via one or more sensors, the sensor data containing at least a portion of the electromagnetic radiation reflected off of the at least one surface of the vehicle;
analyzing the sensor data based on the reflected electromagnetic radiation and an expected pattern of reflected electromagnetic radiation; and
determining if the vehicle has cosmetic damage on the at least one surface of the vehicle based on the analysis of the sensor data.

9. The method of claim 8, wherein the electromagnetic radiation projected onto the at least one surface of the vehicle is visible light in a selected pattern that becomes distorted when the selected pattern is projected onto an area with cosmetic damage.

10. The method of claim 8, wherein if the reflected electromagnetic radiation matches the expected pattern of reflected electromagnetic radiation, determine that the vehicle does not have cosmetic damage on the at least one surface.

11. The method of claim 8, further comprising:
instructing the vehicle to navigate to a repair facility if the vehicle has cosmetic damage on the at least one surface.

12. The method of claim 8, further comprising:
sending a command to the vehicle after the vehicle has identified an impact event, the command effective to cause the vehicle to navigate to an inspection facility having the projector system.

13. The method of claim 8, further comprising:
generating a damage report if the vehicle is determined to have cosmetic damage on at least a portion of the vehicle;
storing the sensor data and the damage report into a database; and
creating an algorithm based on the sensor data and the damage report,
wherein the algorithm is configured to receive new sensor data containing at least a second portion of electromagnetic radiation reflected off of at least one surface of a second vehicle and output whether the second vehicle has cosmetic damage.

14. The method of claim 8, further comprising:
instructing the vehicle to return to ridesharing activities or to navigate to a cleaning facility or a charging station if the vehicle does not have cosmetic damage on the at least one surface or that the cosmetic damage is within an acceptable range.

15. A non-transitory computer readable medium comprising computer-executable instructions, the instructions effective to cause one or more processors to:
receive sensor data from a projector system in communication with the one or more processors, the projector system configured to project electromagnetic radiation onto at least one surface of a vehicle and receive, via one or more sensors, sensor data containing at least a portion of the electromagnetic radiation reflected off of the at least one surface of the vehicle;
analyze the sensor data based on the reflected electromagnetic radiation and an expected pattern of reflected electromagnetic radiation; and
determine if the vehicle has cosmetic damage on the at least one surface of the vehicle based on the analysis of the sensor data.

16. The non-transitory computer-readable medium of claim 15, wherein the electromagnetic radiation projected onto the at least one surface of the vehicle is visible light in a selected pattern that becomes distorted when the selected pattern is projected onto an area with cosmetic damage.

17. The non-transitory computer-readable medium of claim 15, wherein if the reflected electromagnetic radiation matches the expected pattern of reflected electromagnetic radiation, determine that the vehicle does not have cosmetic damage on the at least one surface.

18. The non-transitory computer-readable medium of claim 15, wherein the instructions are further effective to cause the one or more processors to:
instruct the vehicle to navigate to a repair facility if the vehicle has cosmetic damage on the at least one surface.

19. The non-transitory computer-readable medium of claim 15, wherein the instructions are further effective to cause the one or more processors to:
send a command to the vehicle after the vehicle has identified an impact event, the command effective to cause the vehicle to navigate to an inspection facility having the projector system.

20. The non-transitory computer-readable medium of claim 15, wherein the instructions are further effective to cause the one or more processors to:
generate a damage report if the vehicle is determined to have cosmetic damage on at least a portion of the vehicle;
store the sensor data and the damage report into a database; and
create an algorithm based on the sensor data and the damage report,
wherein the algorithm is configured to receive new sensor data containing at least a second portion of electromagnetic radiation reflected off of at least one surface of a second vehicle and output whether the second vehicle has cosmetic damage.
